(19) United States
(12) Patent Application Publication
(10) Pub. No.: US 2026/0072886 A1
(43) Pub. Date: Mar. 12, 2026

(54) STORAGE SYSTEM AND DISTRIBUTED DEDUPLICATION METHOD

(71) Applicant: Hitachi Vantara, Ltd., Yokohama-shi (JP)

(72) Inventors: Kazuki MATSUGAMI, Tokyo (JP); Akira DEGUCHI, Tokyo (JP); Tomohiro YOSHIHARA, Tokyo (JP); Takashi NAGAO, Tokyo (JP); Akiyoshi TSUCHIYA, Tokyo (JP)

(73) Assignee: Hitachi Vantara, Ltd., Yokohama-shi (JP)

(21) Appl. No.: 19/078,848

(22) Filed: Mar. 13, 2025

(30) Foreign Application Priority Data
Sep. 11, 2024 (JP) 2024-157586

(51) Int. Cl. G06F 16/215

(52) U.S. Cl. CPC G06F 16/215

(57) ABSTRACT

Provided is a storage system in which a plurality of nodes are connected, in which each of the nodes includes a pool, a volume associated with a storage area of the pool, and a processor configured to process data input to or output from the volume and the pool, the processor that receives a write request creates identification information from data related to the write request and determines a node to store the data based on a range to which a value of the created identification information belongs, and a processor of the node determined to store the data acquires the data related to the write request, performs deduplication using the identification information, and stores the data in the pool of the node.

### CLAIM OF PRIORITY

The present application claims priority from Japanese patent application JP 2024-157586 filed on Sep. 11, 2024, the content of which is hereby incorporated by reference into this application.

### BACKGROUND OF THE INVENTION

### 1. Field of the Invention

The present invention relates to deduplication in a storage system, and is suitable for application to a storage system employing a loosely coupled scale-out architecture and to a deduplication method in such a storage system.

### 2. Description of Related Art

There is an increasing need to utilize big data, such as data analysis using artificial intelligence (AI), and there is a demand for efficiently storing and managing massive amounts of data. When an amount of data to be analyzed increases, the IO performance required to satisfy a processing time requirement increases, and thus it is necessary to flexibly extend computing resources such as host computers and storage systems according to the amount of data. Scale-out storage is widely used because it allows not only increased storage capacity but also expansion of computing resources by adding appliances (nodes). Specifically, a storage system using a loosely coupled scale-out method in which nodes are clustered has become mainstream. In the above-described architecture, distributed deduplication is used as a method of efficiently storing data with a small capacity.

Distributed deduplication is a technology that extends the deduplication technology that eliminates duplicate data within one node to scale-out storage including a plurality of nodes, and can store data more efficiently by reducing duplicated data between a plurality of nodes. For example, the distributed deduplication technology is disclosed in PTL 1.

### CITATION LIST

### Patent Literature

PTL 1: U.S. Pat. No. 9,020,900

### SUMMARY OF THE INVENTION

The scale-out storage can distribute the load of IO processing among nodes by distributing the data among the nodes in a system. However, when a new node is added, it is necessary to move the data to the added node and redistribute the load. The redistribution of the load requires movement of the data to a new location, deletion from an old location, update of metadata, and the like, and a large amount of traffic is generated in a network among the nodes.

In general, in the deduplication, the data is divided into specific blocks, hash values of the divided data (chunks) are obtained by using a hash algorithm such as SHA1, and matches in the hash values are found, thereby eliminating duplicate data. Distributed deduplication in the related art has a mapping relationship that refers to original chunks distributed to each node within and between nodes. Therefore, when rearranging data in response to load redistribution, movement and deletion of the data and mapping updates need to be performed in units of chunks across the nodes. Since the reduction effect of the deduplication increases as the size of the chunk decreases, the size of the chunk is often set to about several kilobytes. On the other hand, when the size of the chunk decreases, the number of chunks to be processed increases, the time required for the data rearrangement increases, and scalability is impaired.

The invention has been made in view of the above points, and an object thereof is to propose a storage system and a deduplication method capable of improving scalability by implementing efficient data rearrangement while maintaining a reduction effect by distributed deduplication.

An example of the invention disclosed in the present application is as follows. A storage system in which a plurality of nodes are connected, in which each of the nodes includes a pool, a volume associated with a storage area of the pool, and a processor configured to process data input to or output from the volume and the pool, the processor that receives a write request creates identification information from data related to the write request and determines a node to store the data based on a range to which a value of the created identification information belongs, and a processor of the node determined to store the data acquires the data related to the write request, performs deduplication using the identification information, and stores the data in the pool of the node.

According to one aspect of the invention, by associating the mapping of data between nodes on a 1:1 basis, it is possible to rearrange the data in units of volumes. While maintaining the reduction effect of the distributed deduplication between nodes, movement and deletion of data and mapping updates in units of chunks across nodes become not necessary at the time of data rearrangement, which are necessary in the related art, the processing time of data rearrangement is shortened by the movement of data in units of volumes, and the scalability of the scale-out storage can be improved. Problems, configurations, and effects other than those described above will be clarified by the description of the following embodiments.

### BRIEF DESCRIPTION OF THE DRAWINGS

FIG. 1 is a block diagram illustrating a logical configuration example of a storage system according to a first embodiment of the invention.

FIG. 2 is a block diagram illustrating a hardware structure example of the storage system.

FIG. 3 is a diagram illustrating a configuration example of a memory of the storage system.

FIG. 4 is a diagram illustrating an example of a volume management table.

FIG. 5 is a diagram illustrating an example of a data distribution destination management table.

FIG. 6 is a diagram illustrating an example of a free area management table.

FIG. 7 is a diagram illustrating an example of a logical address translation table.

FIG. 8 is a diagram illustrating an example of a pool management table.

FIG. 9 is a diagram illustrating an example of a hash value management table.

FIG. 10 is a diagram illustrating an example of an external volume management table.

FIG. 11 is a diagram illustrating an example of a volume movement management table.

FIG. 12 illustrates a processing image of write processing.

FIG. 13 is a diagram illustrating a procedure example of deduplication at a time of writing.

FIG. 14 is a diagram illustrating an example of a procedure example of logical address allocation at the time of writing.

FIG. 15 is a diagram illustrating a processing image of volume movement processing.

FIG. 16 is a flowchart illustrating a processing procedure example of write processing on a front end side.

FIG. 17 is a flowchart illustrating a processing procedure example of the write processing on a back end side.

FIG. 18 is a flowchart illustrating a processing procedure example of read processing.

FIG. 19 is a flowchart illustrating a procedure example of volume data copy processing in volume movement.

FIG. 20 is a flowchart illustrating a procedure example of switching processing of an external volume that is performed after data copy between volumes in the volume movement is completed.

FIG. 21 is a diagram illustrating a procedure example for logical address allocation at a time of writing in a storage system according to a second embodiment of the invention.

FIG. 22 is a diagram illustrating a processing procedure of write processing in a storage system according to a third embodiment of the invention.

### DESCRIPTION OF EMBODIMENTS

Hereinafter, embodiments according to the invention will be described in detail with reference to the drawings.

The following description and drawings are examples for describing the invention and are omitted and simplified as appropriate for clarity of description. Not all combinations of features described in the embodiments are necessarily required for the solution of the invention. The invention is not limited to the embodiments, and any application example that matches the idea of the invention is within the technical scope of the invention. Those skilled in the art can make various additions and modifications to the invention within the scope of the invention. The invention can be implemented in various other forms. Unless otherwise specified, each component may be single or plural.

In the following description, descriptions may be given using expressions such as “tables,” “charts”, “lists,” and the like, and various types of information may be expressed in other data structures. To indicate that the information does not depend on the data structure, “XX table”, “XX list”, and the like may be referred to as “XX information”. When describing information contents, expressions such as “identification information”, “identifier”, “name”, “ID”, “number”, and the like are used, and the expressions may be replaced with one another.

In the following description, when the elements of the same type are described without being distinguished from each other, reference numerals or common numbers in the reference numerals are used. When the elements of the same type are described by being distinguished from each other, the reference numeral of the element may be used, or an ID, an identification number, or the like assigned to the element may be used instead of the reference numeral. For example, when describing a “storage node” without making any particular distinction, it may be written as a “node 100,” whereas when describing individual nodes 100 with distinction, they may be written as a “node #1,” a “node #2”, and the like.

In addition, in the following description, processing performed by executing a program may be described, and the program may be executed by at least one processor (for example, a CPU), thereby executing predetermined processing using a storage resource (for example, a memory) and/or an interface device (for example, a communication port) as appropriate. Therefore, the subject of the processing may be the processor. Similarly, the subject of the processing performed by executing the program may be a controller, a device, a system, a computer, a node, a storage system, a storage device, a server, a management computer, a client, or a host including a processor. The subject (for example, a processor) of the processing performed by executing the program may include a hardware circuit that performs a part or all of the processing. For example, the subject of the processing performed by executing the program may include a hardware circuit that executes encryption and decryption or compression and decompression. The processor operates as a functional unit that implements a predetermined function by operating according to the program. A device and a system including the processor are a device and a system including such a functional unit.

The program may be installed from a program source on a device such as a computer. The program source may be, for example, a program distribution n server or a computer-readable non-transitory storage medium. When the program source is the program distribution server, the program distribution server may include a processor (for example, a CPU) and a non-transitory storage resource, and the storage resource may further store a distribution program and a program to be distributed. When the processor of the program distribution server executes the distribution program, the processor of the program distribution server may distribute the program to be distributed to another computer. In the following description, two or more programs may be implemented as one program, or one program may be implemented as two or more programs.

### (1) First Embodiment

### (1-1) System Configuration

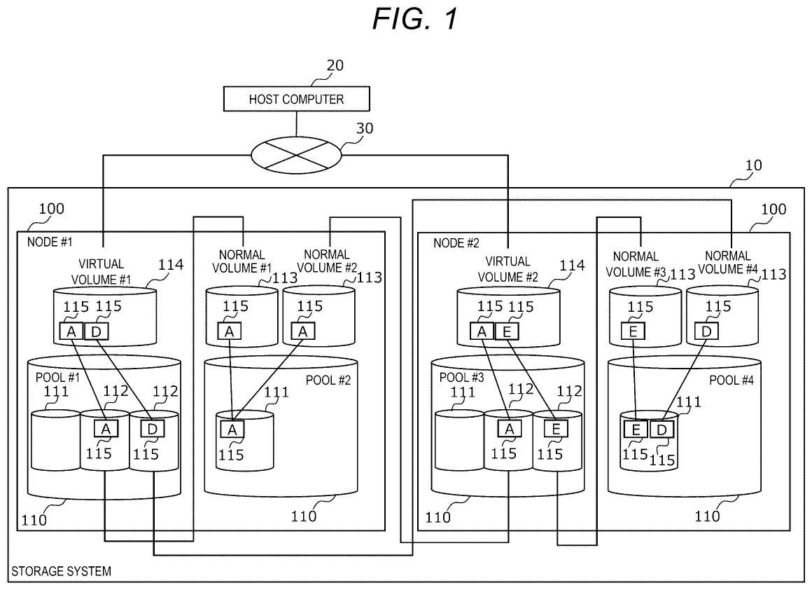

FIG. 1 is a block diagram illustrating a logical configuration example of a storage system 10 according to a first embodiment of the invention.

The storage system 10 is a storage system employing a loosely coupled scale-out architecture and includes a plurality of nodes 100 (for example, a node #1 and a node #2). As illustrated in FIG. 1, each node 100 includes pools 110, pool volumes 111, virtual pool volumes 112, normal volumes 113, and a virtual volume 114 as logical configurations. The storage employing the loosely coupled scale-out architecture has a scale-out function capable of expanding the performance or the capacity as necessary from a small-scale configuration. A loosely coupled scale-out method in which a plurality of appliances (for example, the nodes 100) are clustered is mainstream. The storage system illustrated in FIG. 1 also employs this scale-out method and is not limited thereto.

The virtual volume 114 (for example, a virtual volume #1, a virtual volume #2) is a logical storage area managed by the storage system 10 and provides a virtual capacity to a host computer 20 by thin provisioning. The virtual volume 114 is associated, by a volume management table 141 to be described later, with the pool 110 (a pool #1, a pool #3) obtained by integrating one or more of the pool volumes 111 and one or more of the virtual pool volumes 112.

The pool volume 111 is a logical storage device managed by the storage system 10 and corresponds to a storage area of one or more drives 12 to be described later.

The virtual pool volume 112 is a logical storage device managed by the storage system 10 and is associated with the normal volume 113 (for example, volumes #1 to #4) by an external volume management table 147 to be described later.

The normal volume 113 is a logical storage area managed by the storage system 10 and provides a virtual capacity to the virtual pool volume 112 by thin provisioning. The normal volume 113 is associated, by the volume management table 141 to be described later, with the pool 110 (for example, a pool #2, a pool #4) obtained by integrating one or more pool volumes 111.

Data written from the host computer 20 to the virtual volume 114 is managed in units of chunks 115. The virtual pool volume 112 serving as a storage destination is selected for the chunk 115 by a data distribution destination management table 142 to be described later, a logical address of the storage destination is allocated to the chunk 115 by a free area management table 143 to be described later, and the chunk 115 is associated with a logical address of the virtual pool volume 112 by a logical address translation table 144 to be described later.

Data written to the chunk 115 associated with the logical address of the virtual pool volume 112 is written to the normal volume 113 mapped to the virtual pool volume 112 via a storage network 30. This is the function of circumscription (external connection) in the present embodiment. The data written from the virtual pool volume 112 to the normal volume 113 is managed in units of the chunk 115 and is associated with a logical address of the pool volume 111 by the logical address translation table 144 to be described later.

For example, in the case of FIG. 1, the virtual volume #1 is associated with the pool #1 including the pool volume 111 and the virtual pool volumes 112, and the chunk 115 of “A” of the virtual volume #1 is assigned the logical address in the virtual pool volume 112 and is written to a normal volume #1 via the storage network 30. The normal volume #1 is associated with the pool #2 including the pool volume 111, and the chunk 115 of “A” of the normal volume #1 is allocated to the pool volume 111 of the pool #2.

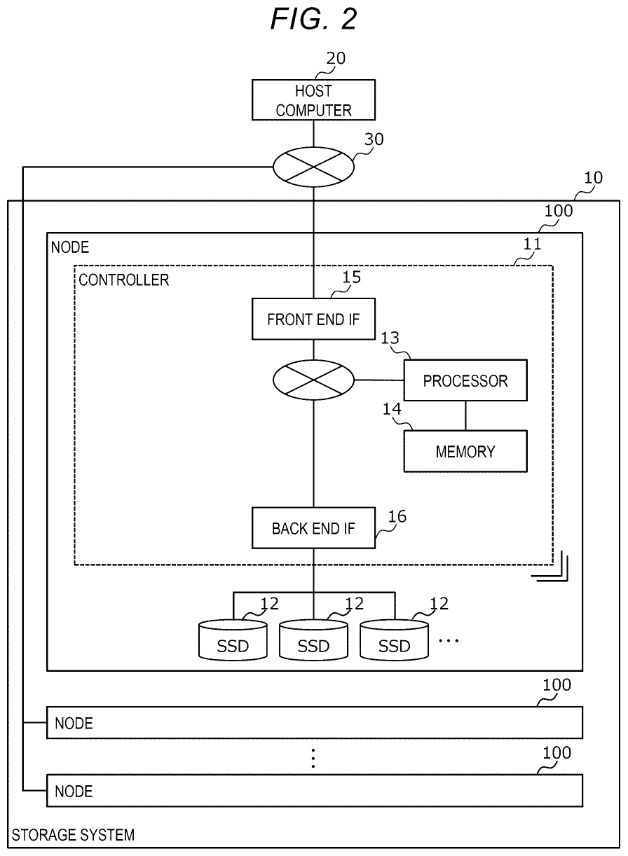

FIG. 2 is a block diagram illustrating a hardware configuration example of the storage system 10.

As described with reference to FIG. 1, the storage system includes the plurality of nodes 100. The storage system 10 is connected to the host computer 20 via the storage network 30.

The host computer 20 transmits an I/O request (a write request or a read request) in which an I/O destination is specified to a controller 11 of the storage system 10.

For example, the storage network 30 is a fiber channel (FC) network.

The node 100 includes one or more of the controllers 11 and a plurality of physical drives 12 (SSDs). The physical drive 12 is connected to each controller 11, and one or a plurality of physical drives 12 are allocated to each controller 11. For example, the physical drive 12 is illustrated as a solid state drive (SSD) in FIG. 2, but is not limited thereto and may be any device that physically stores data, such as a hard disk drive (HDD).

The controller 11 includes one or more processors 13, one or more memories 14, a front end IF 15, and a back end IF 16.

The processor 13 is a processor that implements various controls by executing a program read from the memory 14. In the present embodiment, the processor 13 performs control related to the movement of volumes between the nodes 100 in addition to writing and reading of data. The processor 13 is, for example, a central processing unit (CPU), but is not limited thereto.

The memory 14 is a storage unit that stores the program executed by the processor 13, data used by the processor 13, and the like.

The front end IF 15 is a communication interface device that mediates data exchange with the host computer 20. The controller 11 is connected to the host computer 20 from the front end IF 15 via the storage network 30.

The back end IF 16 is a communication interface device that mediates data exchange between the physical drive 12 and the controller 11. The plurality of physical drives 12 are connected to the back end IF 16.

### (1-2) Memory Configuration

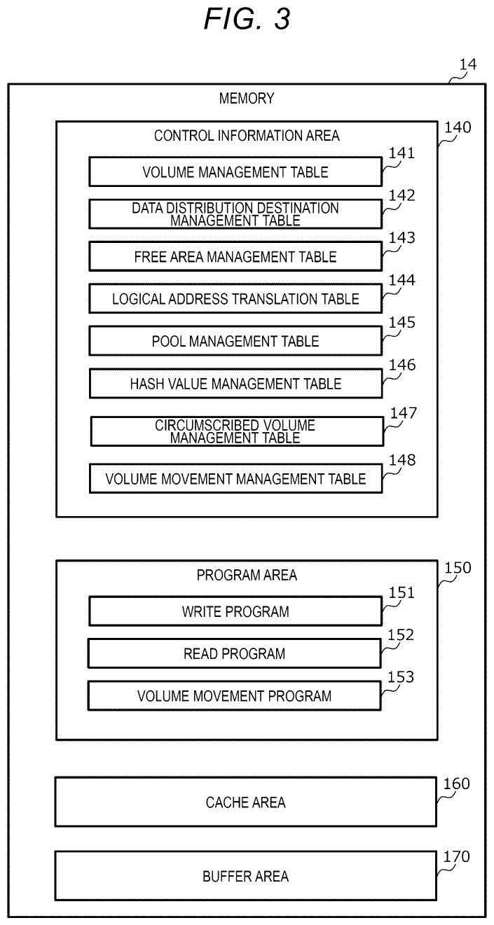

FIG. 3 is a diagram illustrating a configuration example of the memory 14 of the storage system 10 and is a diagram illustrating an example of a program and control data in the memory 14 that are used by the storage system 10.

The program and the control data used by the storage system (mainly the controller 11) are read into the memory 14 and executed or used by the processor 13.

As illustrated in FIG. 3, the memory 14 includes memory areas of a control information area 140 that stores the control data, a program area 150 that stores the program executed by the processor 13, a cache area 160 that serves as a cache, and a buffer area 170 that temporarily stores data for operations such as data sorting.

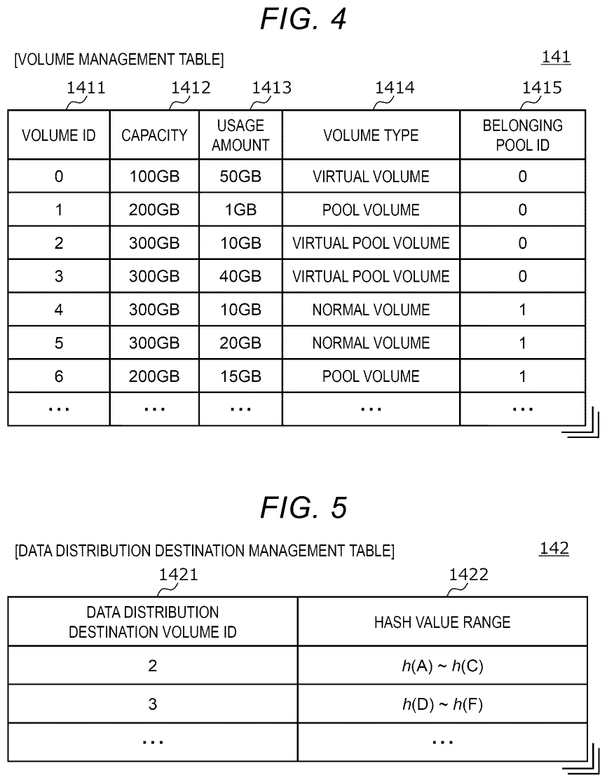

The control information area 140 stores the volume management table 141, the data distribution destination management table 142, the free area management table 143, the logical address translation table 144, a pool management table 145, a hash value management table 146, the external volume management table 147, and a volume movement management table 148. FIGS. 4 to 11 to be described later illustrate a configuration example of each of the tables.

The program area 150 stores a write program 151, a read program 152, and a volume movement program 153. These programs are provided for each of the plurality of controllers 11 and cooperate to perform target processing. Details of processing in each program will be described later.

The cache area 160 temporarily stores a data set written to or read from the physical drive 12.

The buffer area 170 temporarily stores operation target data when operations such as sorting, compression, and encryption of data are performed.

FIG. 4 is a diagram illustrating an example of the volume management table 141.

The volume management table 141 is control data for managing information on volumes such as the virtual volume 114, the normal volume 113, the virtual pool volume 112, and the pool volume 111. The volume management table 141 includes items of a volume ID 1411, a capacity 1412, a usage amount 1413, a volume type 1414, and a belonging pool ID 1415.

The volume ID 1411 indicates a volume identifier. The capacity 1412 indicates a capacity allocated to a volume identified by the volume ID 1411 (hereinafter, the volume), and the usage amount 1413 indicates a current usage amount in the volume.

The volume type 1414 indicates a type of the volume.

The belonging pool ID 1415 indicates an identifier of the pool 110 to which the volume belongs.

FIG. 5 is a diagram illustrating an example of the data distribution destination management table 142.

The data distribution destination management table 142 is control data for managing a range of hash values of data allocated to the virtual pool volume 112. The data distribution destination management table 142 includes items of a data distribution destination volume ID 1421 and a hash value range 1422.

The data distribution destination volume ID 1421 indicates an identifier (a volume ID) of the virtual pool volume. The hash value range 1422 indicates a hash value range of the data allocated to the virtual pool volume 112 identified by the data distribution destination volume ID 1421. In the present embodiment, since the data is processed in units of chunks 115, a hash value is created for each chunk 115. The hash value range 1422 is specified based on the created hash value, and a volume ID of the virtual pool volume 112 indicated by the corresponding data distribution destination volume ID 1421 is acquired.

As to be described later, the hash value is an example of identification information for the chunk 115, and a value (for example, a modulo) other than the hash value may be used as the identification information. The same applies to hash values to be described later. In either case, a range of a value of the identification information is set for each virtual pool volume 112, the chunks 115 are classified according to the range to which the value of the identification information belongs, and the virtual pool volume in which the classified range is set is selected as an allocation destination.

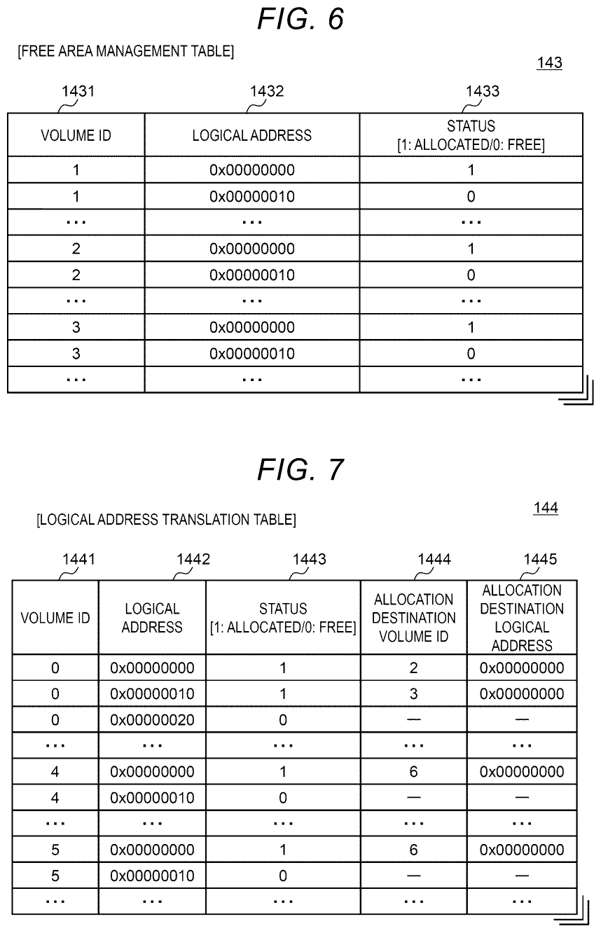

FIG. 6 is a diagram illustrating an example of the free area management table 143.

The free area management table 143 is control data for managing a free area of the virtual pool volume 112. The free area management table 143 includes items of a volume ID 1431, a logical address 1432, and a status 1433.

The volume ID 1431 indicates an identifier of the virtual pool volume 112. The logical address 1432 indicates an address of a logical address space of the virtual pool volume 112 in units of chunks. The status 1433 indicates whether data is allocated to the logical address space of the virtual pool volume 112 as “1” if the data is allocated and as “0” if the data is unallocated (free).

FIG. 7 is a diagram illustrating an example of the logical address translation table 144.

The logical address translation table 144 is data for managing a correspondence relationship between a logical address 1442 of the virtual volume 114 and a logical address 1445 of the virtual pool volume 112, or between the logical address 1442 of the normal volume 113 and the logical address 1445 of the pool volume 111. The logical address translation table 144 includes items of a volume ID 1441, the logical address 1442, a status 1443, an allocation destination volume ID 1444, and an allocation destination logical address 1445.

The volume ID 1441 indicates identifiers of the virtual volume 114 and the normal volume 113. The logical address 1442 indicates logical addresses of the virtual volume 114 and the normal volume 113. In the present embodiment, since the data is processed in units of chunks, the logical address 1442 in FIG. 7 is indicated by an address for each chunk. The status 1443 indicates whether data is allocated to the logical address spaces of the virtual volume 114 and the normal volume 113 as “1” if the data is allocated and as “0” if the data is unallocated (free). The allocation destination volume ID 1444 indicates identifiers of the virtual pool volume 112 and the pool volume 111 as the allocation destination. The allocation destination logical address 1445 indicates a logical address (a start address) of a data storage destination of the virtual pool volume 112 and the pool volume 111 as the allocation destination.

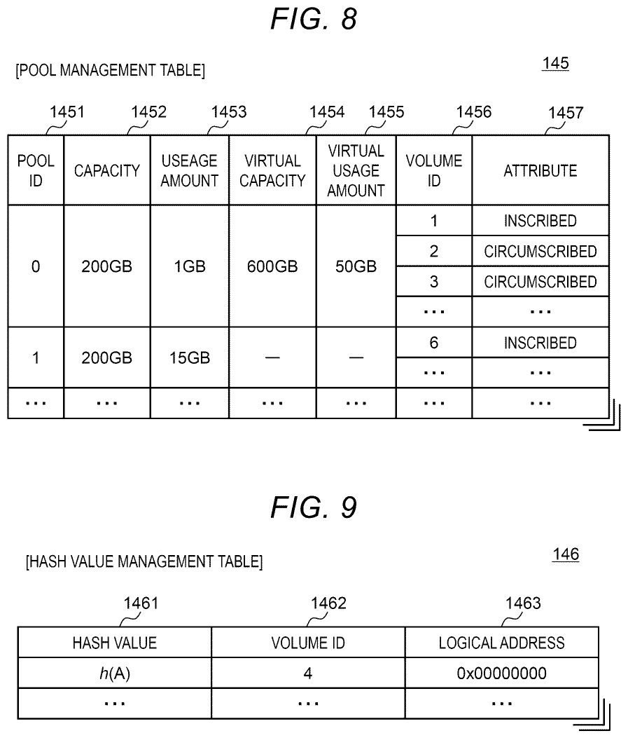

FIG. 8 is a diagram illustrating an example of the pool management table 145.

The pool management table 145 is control data for managing the pool 110. The pool management table 145 includes items of a pool ID 1451, a capacity 1452, a usage amount 1453, a virtual capacity 1454, a virtual usage amount 1455, a volume ID 1456, and an attribute 1457.

The pool ID 1451 indicates a pool identifier. The capacity indicates a capacity allocated by integrating the pool volumes 111 which belong to a pool identified by the pool ID 1451 (hereinafter referred to as the pool). The usage amount 1453 indicates a current usage amount in the pool.

The virtual capacity 1454 indicates a capacity of entity data present in another pool allocated by integrating the virtual pool volumes 112 which belong to the pool. The virtual usage amount 1455 indicates a usage amount of the capacity indicated by the virtual capacity 1454.

The volume ID 1456 indicates volumes ID of the virtual pool volume 112 and the pool volume 111 which belong to the pool. The attribute 1457 indicates whether entity data of a volume identified by the volume ID 1456 is “inscribed”, which means being present in the pool, or is “external”, which means being present in another pool.

FIG. 9 is a diagram illustrating an example of the hash value management table 146.

The hash value management table 146 (hereinafter, referred to as the table) is control data for managing the hash value created for each chunk 115 using a hash algorithm and for managing an identifier or a logical address of a volume of a storage destination of the chunk, and is used to determine the presence or absence of duplicate data by searching the table for information whose hash value matches.

A hash value 1461 is specific identification information used to identify data (hereinafter, referred to as the data), and indicates, for example, a hash value created by the hash algorithm.

The volume ID 1462 indicates an identifier (a volume ID) of the normal volume 113 which is a storage destination of the data (hereinafter, referred to as the volume).

The logical address 1463 indicates a logical address of a storage destination of the data stored in the volume.

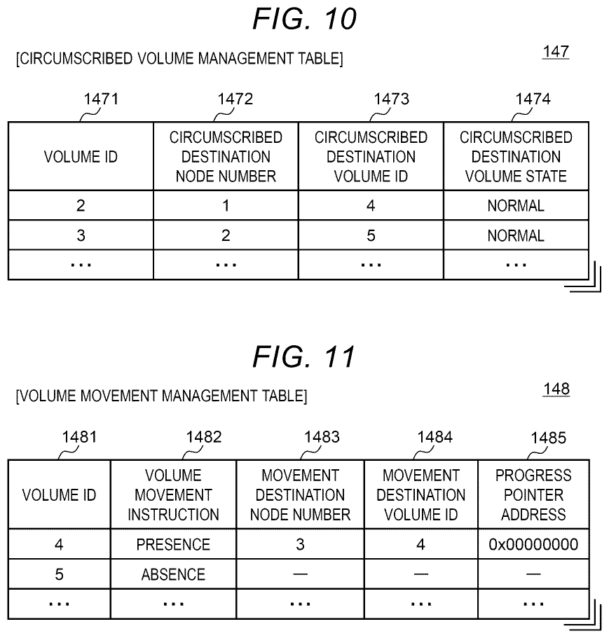

FIG. 10 is a diagram illustrating an example of the external volume management table 147.

The external volume management table 147 is control data for managing a node number of the node 100 to which the normal volume 113, which is a connection destination of the virtual pool volume 112, belongs and for managing a volume ID of the normal volume 113. The external volume management table 147 includes items of a volume ID 1471, an external destination node number 1472, an external destination volume ID 1473, and an external destination volume state 1474.

The volume ID 1471 indicates an identifier (a volume ID) of the virtual pool volume 112 (hereinafter, the volume).

The external destination node number 1472 indicates an identifier (a node number) of the node 100 to which the normal volume 113 (hereinafter, a connection destination volume), which is a connection destination of the volume, belongs.

The external destination volume ID 1473 indicates an identifier (a volume ID) of the connection destination volume of the volume.

The external destination volume state 1474 indicates a volume state such as “normal” which is a state in which an IO to the connection destination volume is possible or “blocked” which is an abnormal state.

FIG. 11 is a diagram illustrating an example of the volume movement management table 148.

The volume movement management table 148 is control data used to move data among nodes. The volume movement management table 148 includes items of a volume ID 1481, a volume movement instruction 1482, a movement destination node number 1483, a movement destination volume ID 1484, and a progress pointer address 1485.

The volume ID 1481 indicates an identifier (a volume ID) of the normal volume 113 (hereinafter, the volume). The volume movement instruction 1482 indicates whether the volume is being moved among nodes by displaying “presence” or “absence” of the movement. The movement destination node number 1483 indicates an identifier (a node number) of the node 100 which is a movement destination of the volume. The movement destination volume ID 1484 indicates an identifier (a volume ID) of the normal volume 113 (hereinafter, a movement destination volume) created in the node 100 serving as a movement destination as the movement destination of the volume. The progress pointer address 1485 is information indicating a progress of the movement of the data of the volume, and indicates a logical address (a start address) of the next data in which a copy is completed between the volume and the movement destination volume.

### (1-3) Processing

Hereinafter, as processing executed by the storage system according to the present embodiment, “write processing” executed in response to a write request, “read processing” executed in response to a read request, and “volume movement processing” executed when data is rearranged among the nodes 100 will be described in detail.

### (1-3-1) Write Processing

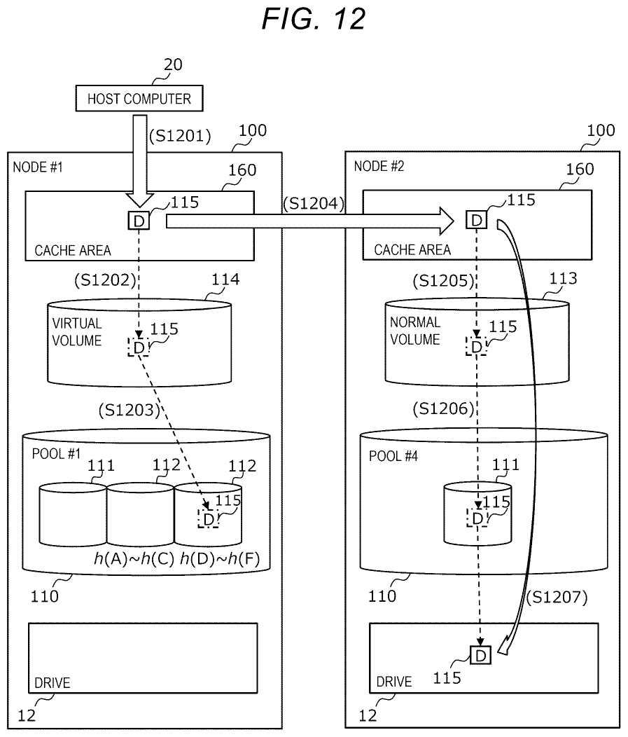

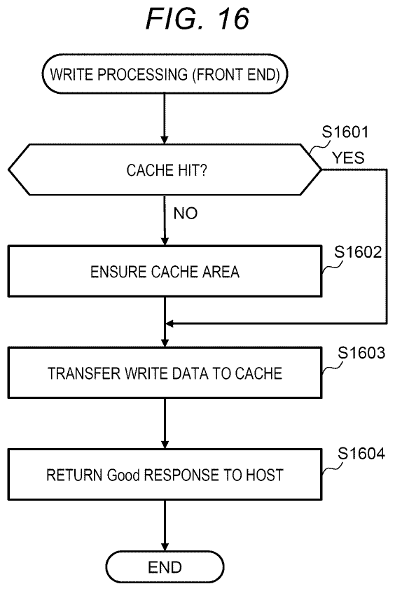

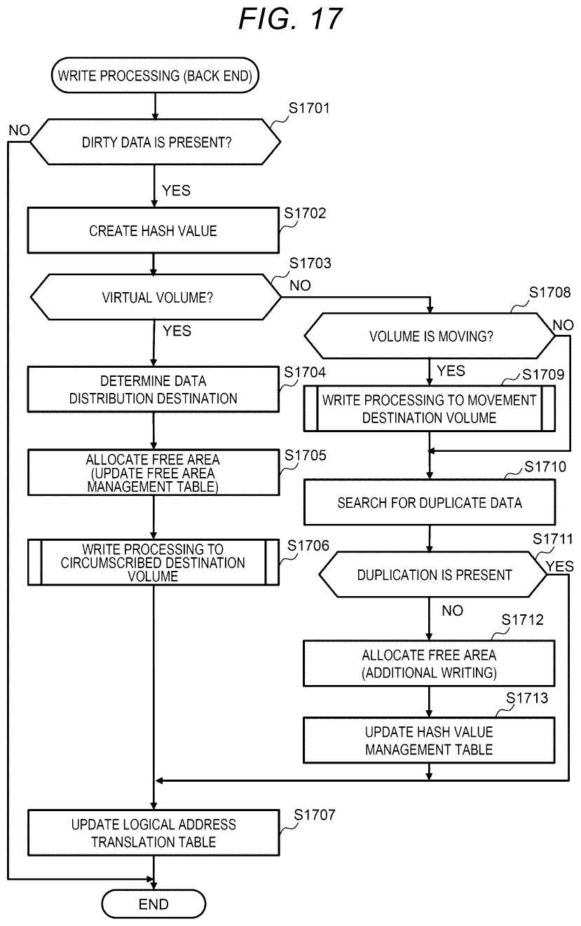

Hereinafter, a series of flows of the write processing will be described using processing images illustrated in FIGS. 12, 13, and 14. Thereafter, details of a processing procedure will be described with reference to flowcharts illustrated in FIGS. 16 and 17.

FIG. 12 illustrates, as the processing image of the write processing, a processing image of the node 100 (the node #1) that has received the write request from the host computer 20 and a processing image of the node 100 (the node #2) that is a storage destination of actual data.

A specific example is as follows.

(S1201) The node #1 receives a write request for the virtual volume 114 from the host computer 20 via the storage network 30. The write request includes data and a logical address of an allocation destination of the data. Upon receiving the write request, the node #1 ensures an area on the cache area 160 for writing the data and writes the data to the ensured area. In the present embodiment, the data written by the host computer 20 is the chunk 115 having a specific size, but the size of the data is not limited, and a size different from the chunk 115 may be designated. When the controller 11 of the node #1 that has received the write request writes the data to the cache area 160, it makes the data on the cache redundant with another controller 11 in the node #1, and the controller 11 responds to the host computer 20 with the completion of the write processing.

(S1202) The node #1 creates a hash value from the chunk 115 written in the cache area 160 using the hash algorithm. In FIG. 12, a hash value “h(D)” is created from a chunk 115 “D”.

In the present embodiment, the hash value of the chunk 115 is calculated as described above, but the hash value is an example of the identification information of the data of the chunk, and a value other than the hash value may be created as the identification information as long as the same identification information is assigned to the same data. For example, a modulo a (remainder) may be created as the identification information by a modulo operation.

(S1203) In the case of writing to the virtual volume 114, the node #1 selects a storage destination of the chunk 115 from one or more of the virtual pool volumes 112. A range of hash values of data to be stored is set in the virtual pool volume 112 in advance, and the node #1 selects the virtual pool volume 112 in which the range of hash values corresponding to the hash value “h(D)” described above is set as the storage destination. In the example of FIG. 12, the pool 110 (the pool #1) in the node #1 includes the virtual pool volume 112 in which a range of hash values h(A) to h(C) is set and the virtual pool volume 112 in which a range of hash values h(D) to h(F) are set, and the latter one is selected as the storage destination of the chunk 115 “D”.

(S1204) A write request is issued from the node #1 via the storage network 30 to the normal volume 113 of the node #2 that is the connection destination (that is, the external destination) of the virtual pool volume 112. The write request includes the chunk 115 “D” on the cache area 160 of the node #1 and the same logical address as the allocation destination of the virtual pool volume 112. When the node #2 receives the write request, the node #2 ensures an area for writing data on the cache area 160 and writes the data into the ensured area. Similar to the node #1, the node #2 also makes the data in the cache redundant and responds to the node #1, which is a source of the write request, with a completion of the write processing.

In the present embodiment, the pool volume 111 is used for storage in a host node, and the external destination of the virtual pool volume 112 is the normal volume 113 in another node 100, but the normal volume 113 in the same node 100 may also be the external destination. In this case, the node #1 transmits the write request to the normal volume 113 in the host node from the back end IF 16 via the storage network 30 and executes the same processing as that performed by the node #2 in the above example when the front end IF 15 receives the write request.

(S1205) The node #2 creates the hash value from the chunk 115 written into the cache area 160 of the node #2. Similar to the node #1, the hash value “h(D)” is created from the chunk 115 “D”.

(S1206) When the received request is a write to the normal volume 113, the node #2 searches for duplicate data by using the created hash value. FIG. 12 illustrates a case in which there is no duplicate data, and the pool volume 111 is allocated as the storage destination of the chunk 115. In the present embodiment, a logical address of an allocation destination of the pool volume 111 is determined by a log structure method (so-called “additional writing”).

(S1207) When the logical address on the pool volume 111 is allocated, the node #2 transfers the chunk 115 “D” on the cache area 160 to an area on the corresponding drive 12. For the data written into the area on the drive 12, the data is protected against a drive failure by using a data redundancy technique such as RAID (for example, RAID 5 or RAID 6).

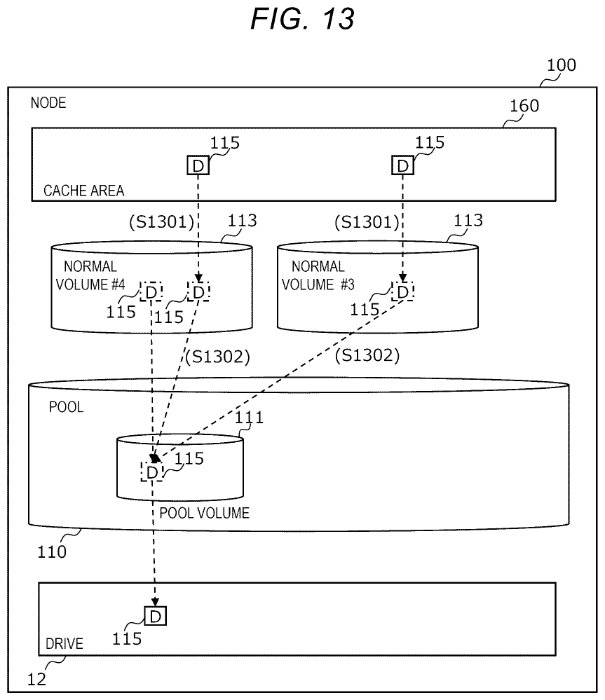

FIG. 13 is a diagram illustrating a procedure example of deduplication at the time of writing. Specifically, a processing image when the duplicate data is found in deduplication processing performed in the node 100 is illustrated.

A specific example is as follows.

(S1301) The hash value “h(D)” is created from the chunk 115 “D” written into the cache area 160 of the node 100. FIG. 13 illustrates a case in which the duplicate data is present in the same normal volume 113 (write to a normal volume #4) and a case in which the duplicate data is present in different normal volumes 113 (write to a normal volume #3).

(S1302) The created hash value is used to search for the duplicate data. In FIG. 13, it is assumed that the chunk 115 “D” is already stored in the normal volume #4, and the stored chunk 115 “D” is detected by searching for duplicate data. Since the data may not be the same even when the hash values are the same, the detected chunk 115 “D” is read to check whether the data is the same. Then, if the data is the same, it is determined that the data is duplicated, and deduplication is performed by mapping the logical address on the pool volume 111 of an allocation destination of the chunk 115 “D”.

For example, it may be considered that the node 100 in FIG. 13 corresponds to the node #2 in FIG. 12, the normal volume #4 in FIG. 13 corresponds to the normal volume 113 in the node #2 in FIG. 12, and the normal volume #3 in FIG. 13 corresponds to another normal volume 113 in the node #2, which is not illustrated in FIG. 12. In this case, the example in FIG. 13 illustrates processing when the node #2 receives the write request of the chunk 115 “D” twice after processing the first write request of the chunk 115 “D” as illustrated in FIG. 12.

For example, two chunks 115 “D” written into the normal volume #4 in FIG. 13 may be written into the virtual volume 114 of the node #1 and transferred to the node #2 serving as the external destination via the virtual pool volume 112 corresponding to the hash value “h(D)” of the pool #1. In contrast, the chunk 115 “D” written into the normal volume #3 in FIG. 13 may be written into the virtual volume 114 of the node #2 and transferred to the node #2 serving as the external destination via the virtual pool volume 112 corresponding to the hash value “h(D)” of the pool 110 in the node #2.

The address of the pool volume 111 is allocated to the first write request of the chunk 115 “D” illustrated in FIG. 12. Thereafter, for the second and subsequent write requests of the chunk 115 “D” illustrated in FIG. 13, deduplication is performed by mapping the already allocated address without allocating a new address of the pool volume 111.

In the present embodiment, in all the nodes 100 included in the storage system 10, the same hash value range is set as the hash value range of the data allocated to the virtual pool volume 112. Then, the virtual pool volume 112 in which the same hash value range is set is mapped to any normal volume 113 in one node 100. Accordingly, no matter which node 100 the data is written to, if the data is the same, the entity thereof is collected in one node 100. By performing deduplication in the node 100, deduplication among all the nodes 100 included in the storage system 10 is implemented.

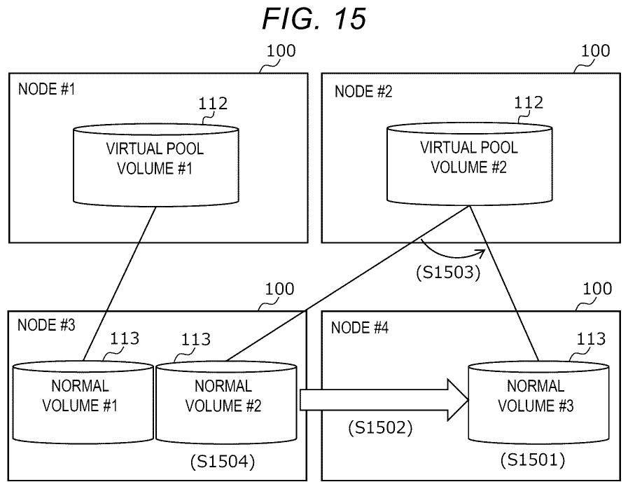

Writing to each normal volume 113 is performed according to a write request to the external destination via the virtual pool volume 112 mapped to each normal volume 113. At this time, the normal volume 113 has 1:1 mapping relationship with the virtual pool volume 112. Accordingly, it is sufficient that the mapping between the normal volume 113 and the virtual pool volume 112 is changed at the time of volume movement to be described later (see FIG. 15 and the like), and there is no need to change the mapping for each chunk 115, and the processing time is shortened.

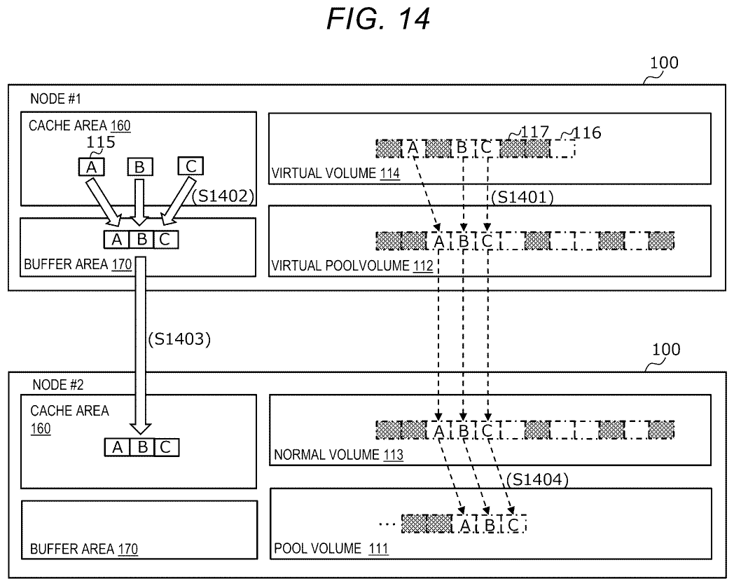

FIG. 14 is a diagram illustrating a procedure example of logical address allocation at the time of writing.

A specific example is as follows.

(S1401) As described in FIG. 12, the virtual pool volume 112 serving as the storage destination is selected according to the hash value created for each chunk 115. When the virtual pool volume 112 serving as the storage destination is selected, an unallocated logical address 116 on the virtual pool volume 112 is allocated to each chunk 115. When writing (update writing) is performed on the allocated logical address 117 on the virtual volume 114, the allocated logical address 117 on the virtual pool volume 112 becomes invalid (the unallocated logical address 116), and another new unallocated logical address 116 is allocated. In FIG. 14, when the chunks 115 “A”, “B”, and “C” are written, an area in which the unallocated logical addresses 116 on the virtual pool volume 112 are continuous is allocated.

(S1402) The chunks 115 “A”, “B”, and “C” in which the logical addresses on the virtual pool volume 112 are continuously allocated are transferred from the cache area 160 to the buffer area 170 such that the entity of the data is the same as an allocation order.

(S1403) A write request is issued from the node #1 to the normal volume 113 of the node #2 serving as the external destination of the virtual pool volume 112. In FIG. 14, the chunks 115 “A”, “B”, and “C” on the buffer area 170 are written as one piece of data. That is, by allocating continuous logical addresses on the virtual pool volume 112 to perform a write between the nodes 100 for each chunk 115, the writes of the plurality of chunks 115 are combined into one write. When the node #2 receives the write request to the normal volume 113, the node #2 stores data in the cache area 160 and responds to the node #1 with the completion of the write.

(S1404) Hash values are created from the chunks 115 “A”, “B”, and “C” as in the description in FIGS. 12 and 13, and a duplicate search is performed. In FIG. 14, the continuous unallocated logical addresses 116 on the pool volume 111 are allocated to chunks 115 “A”, “B”, and “C” on the assumption that there is no duplicate data. The logical address allocation on the pool volume 111 is performed by the additional writing. When writing (update writing) is performed on the allocated logical address 117 on the normal volume 113, the allocated logical address 117 on the pool volume 111 becomes an invalid area (garbage) while remaining in an allocated state, the area is released by recovery processing of the invalid area called garbage collection, and the allocated logical address 117 becomes the unallocated logical address 116.

Accordingly, writing of data of the plurality of chunks for which hash values are calculated to the same external destination can be processed by one write request.

FIG. 16 is a flowchart illustrating a processing procedure example of the write processing on a front end side. Specifically, a flowchart of the write processing on a front end is illustrated, from when the node 100 (the node #1) receives the write request from the host computer 20 to when the node 100 returns a normal write response to the host computer 20.

When the write request is received, the write program 151 is executed to check whether the data of a write destination address is cached in the cache area 160, in other words, whether the data of the write destination address is stored in the cache area 160 (cache hit) (step S1601).

If there is no cache hit (NO in step S1601), the write program 151 ensures a cache area for write data (step S1602) and transfers the write data to the cache area (step S1603). On the other hand, if there is a cache hit (YES in step S1601), the write program 151 skips step S1602 and transfers the write data to the cache area (step S1603). Information (a volume ID, a logical address, and a data length) about the write request received from the host computer 20 is given to the data (dirty data) cached in the cache area 160.

Then, the write program 151 returns a normal response (Good response) to the write request to the host (step S1604) and ends the write processing in the front end.

FIG. 17 is a flowchart illustrating a processing procedure example of write processing on a back end side. Specifically, a flowchart of the write processing in a back end is illustrated, which is performed in the node 100 (the node #1 and the node #2) after the normal response is returned to the host computer 20.

The write program 151 executes the write processing in the back end. The write processing in the back end may be started in synchronization with the completion of the write processing in the front end, or may be started asynchronously or periodically.

In step S1701, the write program 151 checks whether the dirty data is present in the volume (the virtual volume 114 or the normal volume 113). If the dirty data is present (YES in step S1701), the processing proceeds to step S1702, and if the dirty data is not present (NO in step S1701), the processing ends.

In step S1702, the write program 151 creates the hash value for each chunk 115 from the dirty data, and the processing proceeds to step S1703.

In step S1703, the write program 151 checks the volume ID assigned to the dirty data and refers to the volume management table 141 to acquire the matching volume ID 1411 and the corresponding volume type 1414. If the volume type 1414 is the virtual volume 114 (YES in step S1703), the processing proceeds to step S1704, and if the volume type 1414 is not the virtual volume 114 (NO in step S1703), the processing proceeds to step S1708.

In step S1704, the write program 151 selects the virtual pool volume 112 serving as a data write destination. Specifically, the write program 151 refers to the data distribution destination management table 142 to compare the hash value created in step S1702 with the hash value range 1422 and acquires the corresponding data distribution destination volume ID 1421. There may be a plurality of data distribution destination volumes corresponding to the hash value range 1422 in the data distribution destination management table 142, and when there is a plurality of data distribution destination volumes, the capacity 1412 and the usage amount 1413 in the volume management table 141 are checked to select a volume having a small free capacity.

In step S1705, the write program 151 allocates the logical address of the write destination of the selected virtual pool volume 112. Specifically, the write program 151 refers to the free area management table 143 and searches for a row in which the volume ID 1431 corresponds to the data distribution destination volume ID 1421 acquired in step S1704 and the status 1433 is “0: free”. The write program 151 updates the status 1433 of the found row from “0: free” to “1: allocated”, thereby allocating the logical address 1432 on the virtual pool volume 112 serving as the data write destination. A method for searching for a free area on the virtual pool volume 112 is not limited to the implementation method according to the present embodiment. For example, the search may be made more efficient by using a search position pointer for each volume or by managing a specific range of continuous free area in a form of a list or the like.

In step S1706, the write program 151 refers to the external volume management table 147 and acquires the external destination node number 1472 and the external destination volume ID 1473 corresponding to the volume ID 1471 of the virtual pool volume 112. The write program 151 issues a write request to the acquired external destination node number 1472 and external destination volume ID 1473 by specifying the logical address 1432 on the virtual pool volume 112 described above. As described with reference to FIG. 14, the write may be performed for each chunk 115, or the plurality of continuous chunks 115 may be collectively written. The node 100 serving as the external destination, which is designated by the external destination node number 1472, may be the same as the source of the write request or may be another node 100.

In response to the write request to the external destination from the write program 151, the write processing in the front end described in FIG. 16 is performed in the node 100 serving as the external destination, and the normal response (Good response) is returned.

In step S1707, the write program 151 updates the logical address translation table 144. Specifically, the write program 151 registers the allocation destination volume ID 1444 and the allocation destination logical address 1445 of the storage destination of the data in the volume ID 1441 and the logical address 1442 that receives the write request, and sets the status 1443 to “1: allocated”. Accordingly, the logical address of the volume that receives the write request from the host computer 20 is associated with the logical address of the volume allocated as the storage destination of the data in the node 100.

When the update of the logical address translation table 144 in step S1707 is completed, the write processing in the back end is completed. When a update write is performed in a state in which data is already written into the virtual volume 114 (not illustrated), it is necessary to release the allocated logical address on the virtual pool volume 112, which is the allocation destination before update, after the write processing is completed (that is, update the status 1433 in the free area management table 143 to “0: free”).

Step S1708 is a determination related to the volume movement processing, and details thereof will be described later. If the volume movement is not performed, determination in step S1708 is NO, and thus step S1709 is skipped and the processing proceeds to S1710. This case will be described.

In step S1710, the write program 151 searches for the duplicate data by using the hash value created for each chunk 115 from the dirty data. Specifically, the write program 151 refers to the hash value management table 146 and checks whether the matching hash value 1461 is registered. When the matching hash value 1461 is registered, the volume ID 1462 and the logical address 1463 corresponding to the hash value are acquired as mapping destination information.

In step S1711, the processing is switched according to a result of step S1710. If duplication is found in step S1710 (YES in step S1711), the processing proceeds to step S1707, and if duplication is not found (NO in step S1711), the processing proceeds to step S1712.

In step S1712, the write program 151 selects the pool volume 111 serving as the storage destination of the data and the logical address of the storage destination. Specifically, the write program 151 selects, from the volume management table 141, the pool volume 111 having the same belonging pool ID 1415 as that of a write destination volume, and allocates a free area of the pool volume 111. The allocation of the free area is performed by the additional writing as described with reference to FIG. 14. The allocation of the free area during the additional writing is performed by advancing a logical address pointer (not shown) indicating the end of the write destination.

In step S1713, the write program 151 registers information about the hash value, the pool volume 111 allocated in step S1712, and the logical address of the storage destination in the hash value 1461, the volume ID 1462, and the logical address 1463 in the hash value management table 146. The hash value management table 146 may have a structure such as a B-tree to speed up searches and registrations and is not limited to the implementation method according to the present embodiment.

By executing the write processing as described above, the storage system 10 can perform deduplication across the nodes 100. There may be virtual volumes in a storage system to which a deduplication function is not applied. In this case, data written into the virtual volume to which the deduplication function is not applied is stored in the pool volume 111. That is, only the thin provisioning function is applied to the virtual volume.

### (1-3-2) Read Processing

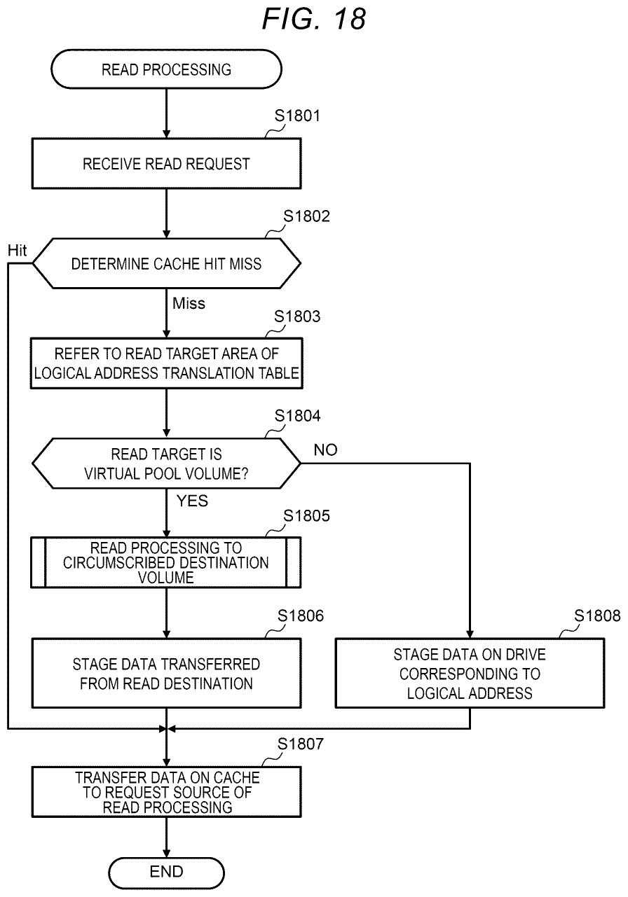

FIG. 18 is a flowchart of a processing procedure example of the read processing.

When a read request for data of a volume (the virtual volume: 114 or the normal volume 113) is made, the read program 152 is executed.

A specific example is as follows.

According to FIG. 18, first, the read program 152 receives the read request (step S1801).

Next, the read program 152 performs cache hit miss determination for determining whether the read data is stored in the cache area 160 (step S1802). If the read data is cache-hit (Hit in step S1802), the read program 152 transfers the cache-hit data to the host (step S1807) and ends the read processing. On the other hand, if the read data has a cache miss (Miss in step S1802), the processing proceeds to step S1803.

In step S1803, the read program 152 refers to a read target area of the logical address translation table 144 and acquires the allocation destination volume ID 1444 and the allocation destination logical address 1445 of the data.

In step S1804, the read program 152 refers to the volume management table 141 to check whether the allocation destination volume ID 1444 acquired in step 1803 is the virtual pool volume 112. If the volume type 1414 is a virtual pool volume (YES in step S1804), the processing proceeds to step S1805, and if the volume type 1414 is not a virtual pool volume (NO in step S1804), the processing proceeds to step S1808.

In step S1805, the read program 152 refers to the external volume management table 147 and acquires the external destination node number 1472 and the external destination volume ID 1473 corresponding to the volume ID 1471 of the volume serving as the allocation destination. The read program 152 issues the read request by designating the logical address on the virtual pool volume 112 in addition to the acquired node and volume. The node 100 that has received the read request similarly executes the read processing illustrated in FIG. 18. When receiving the data from a request destination of the read request, the read program 152 proceeds to step S1806.

In step S1806, the read program 152 stages the data received from the request destination of the read request on the cache area 160 (that is, transfers the data to the cache area 160), proceeds to step S1807, transfers the data to a request source of the read request, and ends the processing.

In step S1808 executed when a read target is not the virtual pool volume 112, the read program 152 reads the data on the drive 12 in the host node 100 corresponding to the allocation destination logical address 1445 acquired in step S1803, and stages the data on the cache area 160. When the staging ends, the read program 152 proceeds to step S1807, transfers the data to the request source of the read request, and ends the processing.

For example, when the processing in FIG. 18 is executed by the node 100 that has received the read request from the host computer 20, a data transfer destination in step S1807 is the host computer 20. In contrast, for example, when the processing in FIG. 18 is executed by the node 100 serving as the external destination that receives the read request transmitted in step S1805, the transfer destination of the data in step S1807 is the node 100 serving as a transmission source of the read request. In the latter case, the node 100 serving as the transmission source of the read request stages the data transferred from the external destination in step S1806.

By executing the read processing as described above, the storage system 10 can read data from the host node and read the data via the node serving as the external destination.

### (1-3-3) Volume Movement Processing

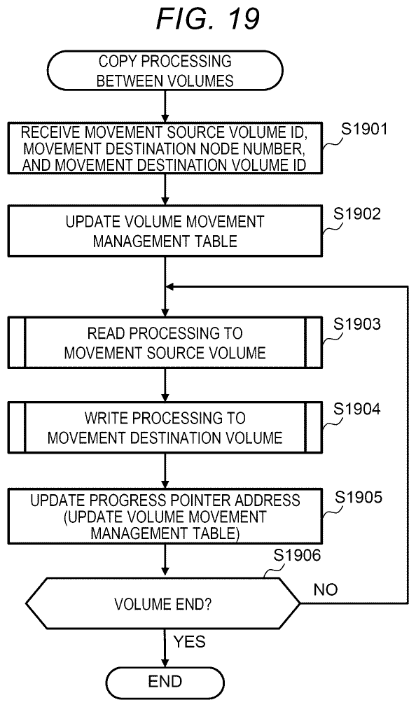

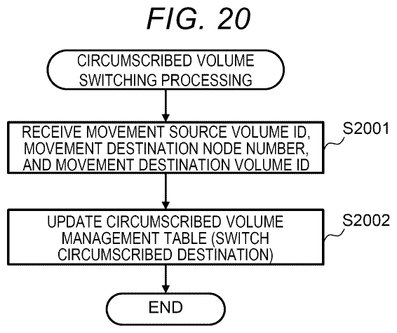

Hereinafter, a processing procedure of the volume movement processing will be described with reference to a processing image illustrated in FIG. 15 and flowcharts illustrated in FIGS. 19 and 20. Processing when the write request is received during the volume movement will be described with reference to FIG. 17.

FIG. 15 is a diagram illustrating the processing image of the volume movement processing.

The volume movement processing is requested by a management server 21 (not illustrated) in response to capacity rebalancing caused by the addition of nodes 100 to the storage system 10. In addition, the volume movement processing may be executed when the node 100 is replaced or the node 100 is removed. A volume that is a target of the volume movement processing may be designated by a user or may be automatically designated by a program. In the present embodiment, the management server 21 manages the arrangement of the volumes of each node 100, and the management server 21 selects a volume to be moved and requests each node to perform processing.

The movement of the volume between the nodes 100 includes a case of moving the virtual volume 114 and a case of moving the normal volume 113. Since the virtual volume 114 does not have an entity of the data and the capacity between nodes does not change even when the virtual volume 114 is moved, the virtual volume 114 is not a movement target in capacity rebalancing. The movement of the virtual volume 114 may be performed with an intention of changing the node 100 serving as the connection destination of the host computer 20. The present embodiment describes a case in which the normal volume 113 is moved to rebalance the capacities between the nodes 100, and FIG. 15 illustrates a case in which a normal volume #2 of a node #3 is moved to a node #4.

When the volume is moved, the normal volume #3 having the same size as that of the normal volume #2 in a movement source is created in advance in the node #4 serving as a movement destination according to an instruction from the management server 21 (step S1501).

Next, the management server 21 requests the node #3 to copy data, and the data is copied between the normal volume #2 in the movement source and the normal volume #3 in the movement destination (step S1502).

When the data copy is completed, the management server 21 instructs the node #2 to switch the external destination, and the connection destination of the virtual pool volume #2 connected to the normal volume #2 as the external destination is switched to the normal volume #3 in the movement destination (step S1503).

When the switching is completed, the volume movement is completed by receiving an instruction to delete a movement source from the management server 21 and deleting the normal volume #2 in the node #3 (step S1504).

FIG. 19 is a flowchart illustrating a procedure example of volume data copy processing in the volume movement.

A specific example is as follows.

When data copying is requested from the management server 21, the volume movement program 153 is executed. The volume movement program 153 receives a movement source volume ID, a movement destination node number, and the movement destination volume ID included in copy requests (step S1901).

In step S1902, the volume movement program 153 updates the volume movement instruction 1482 on the volume movement management table 148 corresponding to a movement target volume to “presence”, and sets the information received in step S1901 in the movement destination node number 1483 and the movement destination volume ID 1484.

In step S1903, the volume movement program 153 stages the data of the volume of the movement source onto the cache area 160. The staging is performed in order from the first logical address of the volume, with a size that is a collection of the plurality of chunks 115 such as slots. The staging is performed by the read processing described with reference to FIG. 18.

In step S1904, the volume movement program 153 writes the data staged in step S1903 to the movement destination volume of the movement destination node. The write request is issued in order from the first logical address of the volume, with the size that is a collection of the plurality of chunks 115 such as slots. The write is performed by the write processing described in FIG. 17.

In step S1905, the volume movement program 153 advances and updates the address in the progress pointer address 1485 in the volume movement management table 148 by a size of data written in step S1904.

In step S1906, the volume movement program 153 determines whether the progress pointer address 1485 in the volume movement management table 148 is an end of the volume by referring to the capacity 1412 of the volume management table 141. Since there is no need to copy data to the movement destination in an area in the volume of the movement source into which no data is allocated, the usage amount 1413 in the volume management table 141 or management information for large data allocation units called pages may be used to omit the copying of unnecessary data (zero data). If determining the volume ends (YES in step S1906), the volume movement program 153 ends the processing. If the volume does not end (NO in step S1906), the processing returns to step S1903 to process the remaining data. If the inter-volume copy processing illustrated in FIG. 19 ends abnormally for some reason, the program can be restarted and the copy processing can be resumed from an address indicated by a copy pointer.

FIG. 20 is a flowchart illustrating a procedure example of switching processing of the external volume that is performed after the data copy between volumes in the volume movement is completed.

A specific example is as follows.

The management server 21 instructs the node 100 to which the virtual pool volume 112 whose external destination is the volume of the movement source belongs to switch the external destination. When the node 100 receives the instruction to switch the external destination, the volume movement program 153 is executed. The volume movement program 153 receives the movement source volume ID, the movement destination node number, and the movement destination volume ID included in the switching instruction of the external destination (step S2001).

The volume movement program 153 finds the external destination volume ID 1473 on the external volume management table 147 that matches the movement source volume ID, and updates the found external destination volume ID 1473 and the external destination node number 1472 corresponding thereto to the movement destination volume ID and the movement destination node number received in step S2001, respectively (step S2002).

A detailed procedure for writing during execution of data copying between volumes will be described with reference to FIG. 17.

A specific example is as follows.

When the write processing on the back end is performed during the volume movement (during data copying), it is necessary to prevent data inconsistency caused by mutual passing with the copy processing. In the present embodiment, in step S1708, the write program 151 refers to the volume movement management table 148 and determines the necessity of writing to the movement destination volume based on the state of the volume movement instruction 1482. If the volume movement instruction 1482 is in “presence” (YES in step S1708), the processing proceeds to step S1709 to request writing to the movement destination volume. If the volume movement instruction 1482 is in “absence” (NO in step S1708), the processing proceeds to step 1710.

By the processing described above, when a write is received during the execution of data copy, the write is reflected in both volumes of the movement source and the movement destination, and data inconsistency can be prevented.

As described above, in the storage system 10 according to the present embodiment, in the loosely coupled scale-out architecture in which a plurality of nodes are clustered, under the constraint that “the reduction effect of the distributed deduplication between the nodes is maintained”, the virtual pool volume 112 and the normal volume 113 between the nodes 100 have a 1:1 mapping relationship, thereby enabling data movement in volume units. Accordingly, processing in units of chunks required in the related art when rearranging data becomes unnecessary, and the effect of improving the scalability of scale-out storage by shortening the processing time for data rearrangement is obtained.

### (2) Second Embodiment

In the first embodiment, when a logical address on the virtual pool volume 112 is allocated, a free area is searched for each chunk 115 by referring to the free area management table 143. However, in this method, the load of the search may increase as the number of the free areas decreases. Therefore, in second embodiment, a storage system in which continuous free areas are always ensured by allocating a logical address on the virtual pool volume 112 by additional writing will be described.

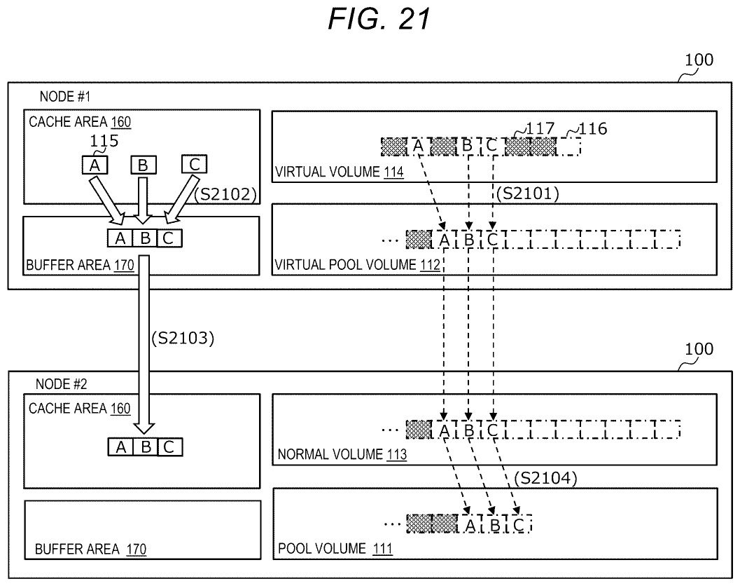

FIG. 21 is a diagram illustrating a procedure example for logical address allocation at a time of writing in a storage system 10 according to the second embodiment of the invention. Since a system configuration of the storage system 10 according to the second embodiment is the same as the system configuration of the storage system 10 according to the first embodiment, the same reference numerals are given and description thereof is omitted.

A specific example is as follows.

(S2101) The virtual pool volume 112 serving as the storage destination is selected according to a hash value created for each chunk 115. When the virtual pool volume 112 serving as the storage destination is selected, the logical address on the virtual pool volume 112 is allocated by the additional writing. An additional writing pointer (not illustrated) indicating the end of the allocated address of the virtual pool volume 112 is referred to, and continuous unallocated logical addresses 116 after the additional writing pointer are allocated. When writing (update writing) is performed on the allocated logical address 117 on the virtual volume 114, the allocated logical address 117 on the virtual pool volume 112 remains in an allocated state and becomes an invalid area (garbage). The area that has become garbage is released by garbage collection that is executed asynchronously with the write processing, and becomes the unallocated logical address 116. In FIG. 21, when the chunks 115 “A”, “B”, and “C” are written, continuous unallocated logical addresses 116 on the virtual pool volume 112 are allocated by additional writing.

(S2102) The chunks 115 “A”, “B”, and “C” in which the logical addresses on the virtual pool volume 112 are continuously allocated are transferred from the cache area 160 to the buffer area 170 such that the entity of the data is the same as an allocation order.

(S2103) A write request is issued from the node #1 to the normal volume 113 of the node #2 serving as the external destination of the virtual pool volume 112. In FIG. 21, as in the first embodiment, the chunks 115 “A”, “B”, and “C” on the buffer area 170 are written as one piece of data. By allocating continuous logical addresses on the virtual pool volume 112 to perform a write between the nodes 100 for each chunk 115, the writes of the plurality of chunks 115 are combined into one write. When the node #2 receives the write request to the normal volume 113, the node #2 stores data in the cache area 160 and responds to the node #1 with the completion of the write.

(S2104) Hash values are created from the chunks 115 “A”, “B”, and “C”, and a duplicate search is performed. In FIG. 21, the continuous unallocated logical addresses 116 on the pool volume 111 are allocated to chunks 115 “A”, “B”, and “C” on the assumption that there is no duplicate data. The allocation of the logical address on the pool volume 111 is performed by additional writing in the same manner as the virtual pool volume 112. When writing (update writing) is performed on the allocated logical address 117 on the normal volume 113, the allocated logical address 117 on the pool volume 111 becomes an invalid area (garbage) in an allocated state, with the area being released by garbage collection executed asynchronously with the write processing, and becomes the unallocated logical address 116.

As described above, the storage system 10 according to the second embodiment can allocate the logical address on the virtual pool volume 112 by additional writing to always ensure a continuous free area, and perform garbage collection at a timing asynchronous with the write processing (such as a time period having a low IO load) to release the allocated area. The influence of garbage collection on the IO performance can be controlled by changing an activation trigger of the garbage collection according to conditions such as the amount of garbage, the free capacity, and the IO load.

### (3) Third Embodiment

In the first embodiment and the second embodiment, data is stored in the drive 12 after deduplication is performed, and the

IO throughput of the storage system 10 may be limited by the processing speed of deduplication. When a high IO throughput is required, for example, when the IO load is high, it is required to change an execution trigger of deduplication (make IO asynchronous).

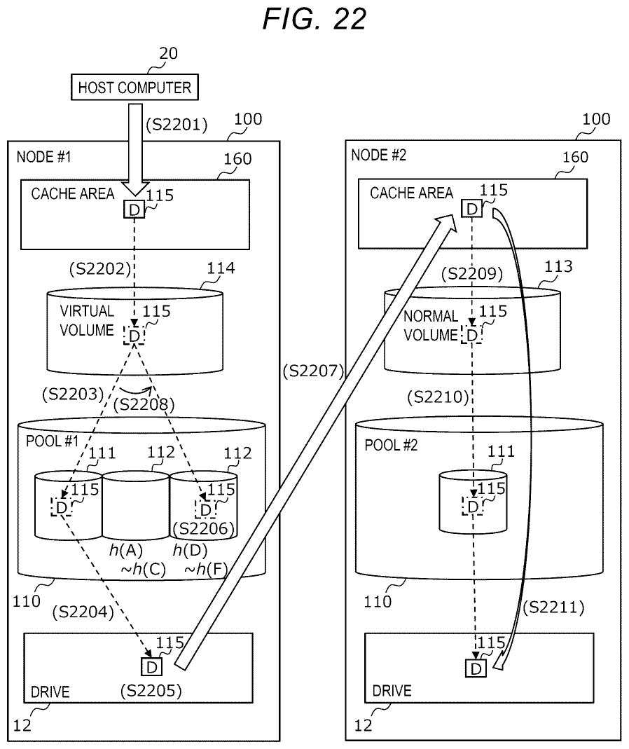

FIG. 22 is a diagram illustrating a processing procedure of write processing in a storage system 10 according to a third embodiment of the invention. Since a system configuration of the storage system 10 according to the third embodiment is the same as the system configuration of the storage system 10 according to the first embodiment, the same reference numerals are given and description thereof is omitted. In the present embodiment, a processing image is illustrated in which the node #1 that has received a write request from the host computer 20 stores data in the drive 12, allocates the data to the node #2 with asynchronous IO, and performs deduplication.

A specific example is as follows.

(S2201) The node #1 receives a write request for the virtual volume 114 from the host computer 20 via the storage network 30. The write request includes data and a logical address of an allocation destination of the data. Upon receiving the write request, the node #1 ensures an area on the cache area 160 for writing the data and writes the data to the ensured area. When the controller 11 of the node #1 that has received the write request writes the data to the cache area 160, it makes the data on the cache redundant with another controller 11 in the node #1, and the controller 11 responds to the host computer 20 with the completion of the write processing.

(S2202) Since the node #1 asynchronously selects the virtual pool volume 112 using the hash value, the creation of the hash value is skipped.

(S2203) The node #1 allocates the pool volume 111 as a storage destination of the chunk 115 “D”. In the present embodiment, the logical address of the allocation destination of the pool volume 111 is determined by additional writing.

(S2204) When the logical address on the pool volume 111 is allocated, the node #1 transfers the chunk 115 “D” on the cache area 160 to an area on the corresponding drive 12.

(S2205) The node #1 reads the chunk 115 allocated to the pool volume 111 to the buffer area 170 at an execution trigger of the asynchronous IO (for example, when the IO load is low or when periodically activated), and creates the hash value using a hash algorithm. In FIG. 22, the hash value “h(D)” is created from the chunk 115 “D”.

(S2206) The node #1 selects a storage destination of the chunk 115 “D” from one or more virtual pool volumes 112. In the virtual pool volume 112, a range of hash values of stored data (for example, h(D) to h (F)) is set in advance, and the virtual pool volume 112 in which the range of the hash value corresponding to the above-described hash value “h(D)” is set is selected as the storage destination.

(S2207) A write request is issued from the node #1 via the storage network 30 to the normal volume 113 of the node #2 that is the connection destination (that is, the external destination) of the virtual pool volume 112. The write request includes the chunk 115 “D” on the buffer area 170 of the node #1 and the same logical address as the allocation destination of the virtual pool volume 112. When the node #2 receives the write request, the node #2 ensures an area for writing data on the cache area 160 and writes the data into the ensured area. Similar to the node #1, the node #2 also makes the data in the cache redundant and responds to the node #1, which is a source of the write request, with a completion of the write processing.

(S2208) When the write processing on the normal volume 113 of the node #2 is completed, the logical address translation table 144 is updated and the logical address on the virtual pool volume 112 is mapped.

(S2209) The node #2 creates the hash value from the chunk 115 written into the cache area 160 of the node #2. Similar to the node #1, the hash value “h(D)” is created from the chunk 115 “D”.

(S2210) When the received request is a write to the normal volume 113, the node #2 searches for duplicate data by using the created hash value. FIG. 22 illustrates a case in which there is no duplicate data, and the pool volume 111 is allocated as the storage destination of the chunk 115.

(S2211) When the logical address on the pool volume 111 is allocated, the node #2 transfers the chunk 115 “D” on the cache area 160 to an area on the corresponding drive 12.

As described above, the storage system 10 according to the third embodiment can execute deduplication processing at any timing by setting the execution trigger of deduplication to be IO asynchronous. In the present embodiment, the deduplication is performed only in the node #2 serving as the external destination. However, a combination in which the deduplication is performed in the node of the node #1, the data is transferred to the node #2 serving as the external destination, and then the deduplication is performed again may be adopted. In addition, deduplication in each node and data transfer between nodes may be performed at an any timing according to conditions such as an IO load and a consumed capacity of each node, and may be controlled according to conditions such as a bandwidth of a network and IOPS in addition to the conditions in the node.

For example, the node 100 may determine whether to give priority to data reduction rate or throughput performance based on a predetermined condition. When it is determined that priority is given to data reduction rate, the write processing according to the first embodiment illustrated in FIG. 12 may be executed. When it is determined that priority is given to throughput performance, the write processing up to step S2205 of the write processing according to the third embodiment illustrated in FIG. 22 may be executed. In the latter case, the node 100 may execute step S2205, and then execute step S2206 and subsequent steps when a predetermined condition for executing deduplication is satisfied.

Alternatively, regardless of whether to give priority to data reduction rate or throughput performance, the node 100 may execute the processing up to step S1205 in FIG. 12, continuously execute the processing of step S1206 and subsequent steps when giving priority to data reduction rate, and perform allocation to the pool volume 111 without performing deduplication in step S1206 and store data when giving priority throughput performance. In the latter case, when a predetermined condition for executing deduplication is satisfied after data is stored in the pool volume 111, the node 100 may read the data stored in the pool volume 111 and perform deduplication in step S1206.

The predetermined condition for executing the deduplication described above may be, for example, any one of conditions such as the IO load of each node 100 being lower than a predetermined reference, the consumed capacity being larger than a predetermined condition, the bandwidth of the storage network 30 being wider than a predetermined reference, or the throughput (IOPS) being higher than a predetermined reference, or a combination thereof. Whether to give priority to the data reduction rate may be determined based on the same condition as described above.

As a result, it is possible to perform processing giving priority to either the data reduction rate or the throughput performance according to the conditions, to perform deduplication at a timing at which the throughput performance is less likely to be affected.

The invention is not limited to the embodiments described above, and includes various modifications. For example, the above-described embodiments are described in detail for a better understanding of the invention, and the invention is not necessarily limited to those including all the configurations described above. A part of a configuration according to one embodiment can be replaced with a configuration according to another embodiment, and a configuration according to one embodiment can also be added to a configuration according to another embodiment. A part of a configuration of each embodiment may be added to, deleted from, or replaced with another configuration.

A part or all of configurations, functions, processing units, processing methods, and the like described above may be implemented by hardware by, for example, designing with an integrated circuit. In addition, the configurations, functions, and the like described above may be implemented by software by a processor interpreting and executing a program for implementing each function. Information such as a program, a table, and a file for implementing each function can be stored in a storage device such as a nonvolatile semiconductor memory, a hard disk drive, and a solid state drive (SSD), or a computer-readable non-transitory data storage medium such as an IC card, an SD card, and a DVD.

Control lines and information lines indicate what is considered to be necessary for explanation, and not necessarily all control lines and information lines are always shown on a product. Actually, almost all components may be considered to be connected to one another.

What is claimed is:

1. A storage system in which a plurality of nodes are connected, wherein
each of the nodes includes
a pool,
a volume associated with a storage area of the pool, and
a processor configured to process data input to or output from the volume and the pool,
the processor that receives a write request creates identification information from data related to the write request and determines a node to store the data based on a range to which a value of the created identification information belongs, and
a processor of the node determined to store the data acquires the data related to the write request, performs deduplication using the identification information, and stores the data in the pool of the node.

2. The storage system according to claim 1, wherein
the pool includes a pool volume mapped to a physical drive configured to store data and a virtual pool volume mapped to the volume of another node, and
the processor stores data determined to be stored in a host node based on the identification information in the pool volume, stores data determined to be stored in another node based on the identification information in the virtual pool volume, and transfers the data to the other node.

3. The storage system according to claim 2, wherein
a plurality of the virtual pool volumes are created for each mapped volume of another node.

4. The storage system according to claim 3, wherein
the processor stores the data in the pool volume when it is determined to store the data related to the write request in the host node based on the identification information, and stores the data in the virtual pool volume mapped to a volume of the other node when it is determined to store the data in the other node.

5. The storage system according to claim 2, wherein
the deduplication is performed between data stored in the pool volume of the same node.

6. The storage system according to claim 1, wherein
the identification information is created by a modulo operation.

7. The storage system according to claim 2, wherein
the identification information is a hash value created using a hash function, and
a hash value range for determining a node to store the data is allocated to the pool volume and the virtual pool volume.

8. The storage system according to claim 4, wherein
the volume includes a virtual volume to be accessed by a host and a normal volume mapped to the virtual pool volume, and
the processor creates the identification information from data received by the virtual volume and determines a node to store the data, and
stores data received by the normal volume from another node in the physical drive via the pool volume.

9. The storage system according to claim 8, wherein
the virtual pool volume includes a virtual pool volume mapped to the normal volume mapped to the same node, and
the data determined to be stored in the host node based on the identification information is stored in the pool volume via the virtual pool volume and the normal volume.

10. The storage system according to claim 2, wherein
when data of the volume is moved to another node, mapping with the volume is moved to a volume of a node serving as a movement destination of the data.

11. The storage system according to claim 2, wherein
the processor determines whether to give priority to data reduction rate or throughput performance, and
the processor that receives the write request determines a node to store the data based on the range to which the value of the identification information belongs and stores the data in the virtual pool volume mapped to the pool volume or a volume of another node when giving priority to the data reduction rate, and
stores the data in the pool volume when giving priority to the throughput.

12. A distributed deduplication method performed by a storage system in which a plurality of nodes are connected,
each of the nodes including
a pool,
a volume associated with a storage area of the pool, and
a processor configured to process data input to or output from the volume and the pool,
the distributed deduplication method comprising:
creating, by the processor that receives a write request, identification information from data related to the write request and determining a node to store the data based on a range to which a value of the created identification information belongs; and
acquiring, by a processor of the node determined to store the data, the data related to the write request, performing deduplication using the identification information, and storing the data in the pool of the node.
